(19) United States
(12) Patent Application Publication
(10) Pub. No.: US 2013/0114962 A1
(43) Pub. Date: May 9, 2013

(54) COMMUNICATION DEVICE, COMMUNICATION SYSTEM, COMMUNICATION METHOD, AND PROGRAM

(71) Applicants: Daisuke Oka, Tokyo (JP); Sadaichirou Oogushi, Tokyo (JP); Taisuke Goto, Tokyo (JP)

(72) Inventors: Daisuke Oka, Tokyo (JP); Sadaichirou Oogushi, Tokyo (JP); Taisuke Goto, Tokyo (JP)

(73) Assignee: NEC CORPORATION, Tokyo (JP)

(21) Appl. No.: 13/811,001

(22) PCT Filed: Jun. 10, 2011
(86) PCT No.: PCT/JP2011/003288

§ 371 Date: Jan. 18, 2013

(30) Foreign Application Priority Data
Jul. 26, 2010 (JP) 2010-166845

(51) Int. Cl. H04J 14/00

(52) U.S. Cl. CPC H04J 14/00
USPC 398/67

(57) ABSTRACT

The communication device is connected with a plurality of user-side devices via a splitter. The communication device includes a matching means for performing matching to determine whether each of a burst delimiter, positioned at a start position of frame data which is a synchronization target in a burst optical signal transmitted from each of the user-side devices, and sync pattern data, positioned from the beginning of the burst optical signal to the burst delimiter in the burst optical signal, matches a predetermined pattern. The communication device also includes a synchronization means for, if matching of the sync pattern data and matching of the burst delimiter by the matching means succeeded, performing synchronization of the frame data on the basis of the position of the burst delimiter in the burst optical signal. The matching means performs matching of the burst delimiter after successful matching of the sync pattern data.

### TECHNICAL FIELD

The present invention relates to a communication device, and in particular, to a communication device adapted to perform frame synchronization of burst signals. The present invention also relates to a communication system, a program, and a communication method.

### BACKGROUND ART

As a system for performing bidirectional communications using an optical data communication network between a station-side device (OLT: Optical Line Terminal) and a plurality of subscriber-side devices (ONU: Optical Network Unit), there is a PON (Passive Optical Network) system to which the 10 G EPON (10 Gigabit Ethernet Passive Optical Network) system defined in IEEE802.3av is applied, for example. In the 10 G EPON system defined in IEEE802.3av, frame synchronization of upstream burst data to be received in a burst mode in a time sharing manner from each of the ONUs, that is, detection of an FEC (Forward Error Correction) code start position, is performed by detecting a 66-bit burst delimiter in the upstream burst and specifying the start position of the frame. For example, Patent Document 1 discloses related art.

Here, an exemplary method of establishing FEC code synchronization by detecting an FEC code start position will be described with reference to FIG. 1. FIG. 1 is a flowchart showing the processing operation of the synchronizer function, defined in IEEE802.3av Clause 76, having the function of FEC code synchronization of upstream burst data (detection of FEC code start position) in the OLT of the 10 G EPON system.

As shown in FIG. 1, the synchronizer function first receives burst data from the PMA function via a 16 bit XSBI 10 G interface, and generates a bit stream from the received data (step S1). Then, when the generated bit stream becomes 66 bits or larger, the synchronizer function performs matching to detect whether a portion from the first bit to the 66^{th} bit of the generated bit stream matches the 66-bit burst delimiter pattern defined in IEEE802.3av Clause 76 within an 11-bit Hamming distance (step S2). It should be noted that the reason that a bit error of up to 11 bits is allowed is because error correction by an FEC code is not applied to the section from the beginning of the burst frame to the burst delimiter, so that frame detection can be performed with an error rate of about 10⁻³.

If the matching failed (undetected) (step S2: No), the synchronizer function shifts the matching position in the bit stream by 1 bit backward from the current 66^{th} bit, and performs matching to detect again. If the matching succeeded (detected) (step S2: Yes), the synchronizer function determines the next bit of the 66^{th} bit, in which the matching succeeded, to be the beginning position of an FEC code string and performs frame synchronization, and acquires an FEC code (step S3).

Then, the acquired FEC code is transmitted to the FEC decoder function of the higher layer. It should be noted that the above-described FEC code acquisition processing is repeated until the following condition is satisfied. That is, if any one of the conditions that an EOB (End Of Burst delimiter) pattern defined in IEEE802.3av Clause 76 is detected from a received bit stream, that FEC code decoding has failed continuously, and that a stop of data reception from the PMA function is detected, is satisfied during the FEC code synchronization, the respective settings used in such burst processing are initialized and the next upstream burst is waited.

[Patent Document 1] JP 2008-67252 A

### SUMMARY

However, with the above-described method, in the case of a communication path with noise or a communication path having a high bit error rate, even in a bit stream which is not a burst delimiter from an ONU, the OLT may erroneously detect it as a burst delimiter and perform erroneous synchronization. For example, in the case of detecting a burst delimiter pattern by the synchronizer function, when data having a close Hamming distance with a burst delimiter pattern is received from an upstream communication path, erroneous synchronization of an FEC code may be caused. As such, if the synchronizer function conforming to IEEE802.3av takes into account a point that when a bit stream matches a burst delimiter pattern with a Hamming distance of 11 bits or less, it is determined as a burst delimiter, or a point that a max BER (Bit Error Rate) when receiving PMD is specified as 10⁻³, there is a high possibility of an occurrence of erroneous synchronization.

Once erroneous synchronization has been established, the synchronizer function of the OLT is in an FEC code synchronized state, and detection of a burst delimiter will not be performed until the condition for terminating the FEC code synchronization is satisfied and the state becomes an FEC code desynchronized state. If the OLT receives a true burst delimiter during this period, such a burst delimiter is not detected by the synchronizer function, so that the entire FEC codes included in such upstream burst cannot be transmitted to the higher layer. This may cause a problem of erroneous detection of an unnecessary alarm such as an FCS (Frame Check Sequence) error (CRC (Cyclic Redundancy Check) error) or frames.

Accordingly, an object of the present invention is to provide a communication device capable of solving the above-described problem which is deterioration in the reliability of a communication device due to an occurrence of erroneous synchronization of frames.

In order to achieve the object, a communication device, which is an aspect of the present invention, is configured to be connected with a plurality of user-side devices via a splitter, and include

a matching means for performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

a synchronization means for, if matching of the sync pattern data and matching of the burst delimiter by the matching means succeeded, performing synchronization of the frame data on the basis of the position of the burst delimiter in the burst optical signal, wherein

the matching means performs matching of the burst delimiter after successful matching of the sync pattern data.

Further, a communication system, which is another aspect of the present invention, includes a plurality of user-side devices connected via a splitter, and a communication device which receives, in a burst mode, a burst optical signal transmitted from each of the user-side devices.

The communication device is configured to include

a matching means for performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

a synchronization means for, if matching of the sync pattern data and matching of the burst delimiter by the matching means succeeded, performing synchronization of the frame data on the basis of the position of the burst delimiter in the burst optical signal, wherein

the matching means performs matching of the burst delimiter after successful matching of the sync pattern data.

Further, a program which is another aspect of the present invention is a program for causing a communication device, connected with a plurality of user-side devices via a splitter, to realize:

a matching means for performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

a synchronization means for, after successful matching of the sync pattern data by the matching means, if matching of the burst delimiter succeeded, performing synchronization of the frame data on the basis of the position of the burst delimiter in the burst optical signal.

Further, a communication method, which is another aspect of the present invention, is configured to include, in a network system including a plurality of user-side devices connected via a splitter and a communication device which receives, in a burst mode, a burst optical signal transmitted from each of the user-side devices:

by the communication device, performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

after successful matching of the sync pattern data, if matching of the burst delimiter succeeded, performing synchronization of the frame data on the basis of the position of the burst delimiter in the burst optical signal.

As the present invention is configured as described above, the present invention is able to provide a highly reliable communication device capable of reducing erroneous synchronization of frames received in a burst mode.

### BRIEF DESCRIPTION OF DRAWINGS

FIG. 1 is a flowchart showing an operation of a communication device related to the present invention.

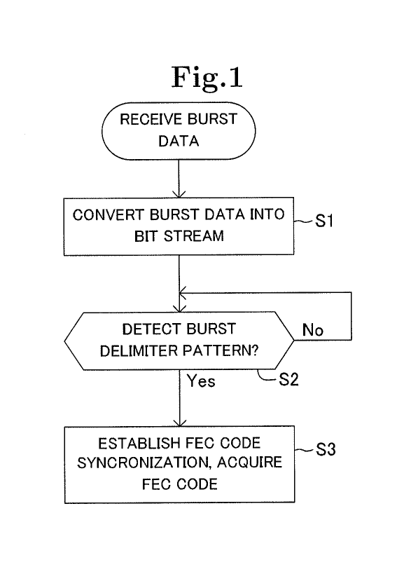

FIG. 2 is a block diagram showing the configuration of a communication system according to a first exemplary embodiment.

FIG. 3 is a block diagram showing the configuration of the center-side device disclosed in FIG. 2.

FIG. 4 is a block diagram showing a configuration of the synchronizer function disclosed in FIG. 3.

FIG. 5 is an illustration showing the configuration of upstream burst data to be received in a burst mode by the center-side device disclosed in FIG. 2.

FIG. 6 is a flowchart showing an outline of the operation of the center-side device disclosed in FIG. 2.

FIG. 7 is a flowchart showing the details of the operation of the center-side device disclosed in FIG. 2.

FIG. 8 is a block diagram showing the configuration of a communication device according to supplementary note 1.

### EXEMPLARY EMBODIMENTS

### First Exemplary Embodiment

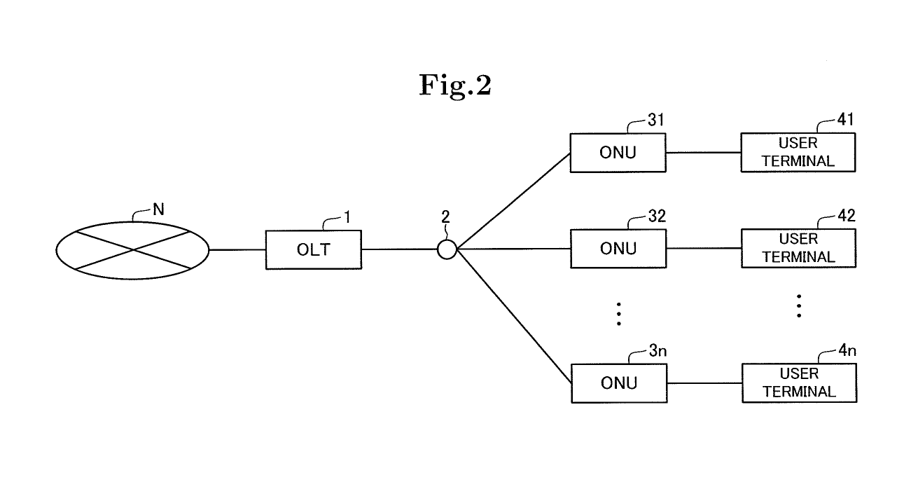

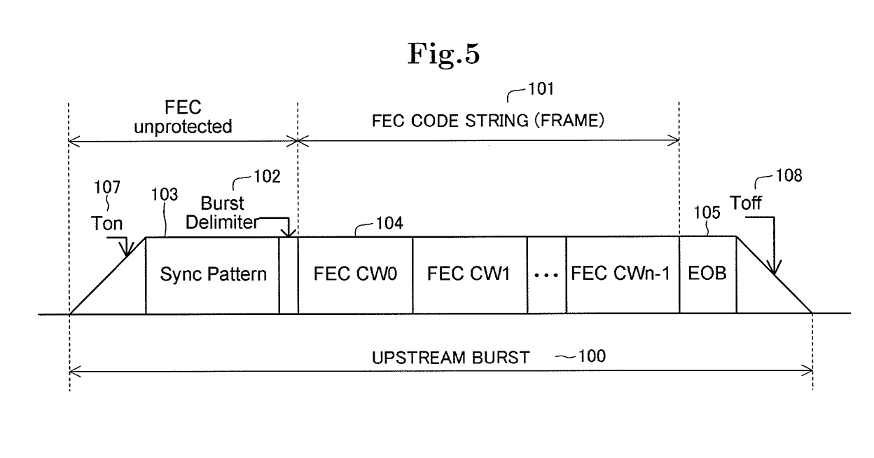

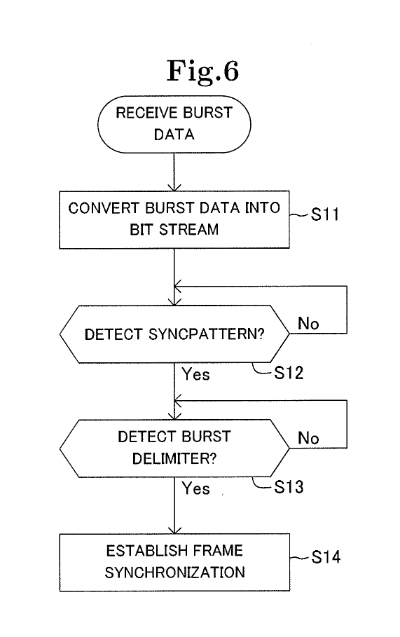

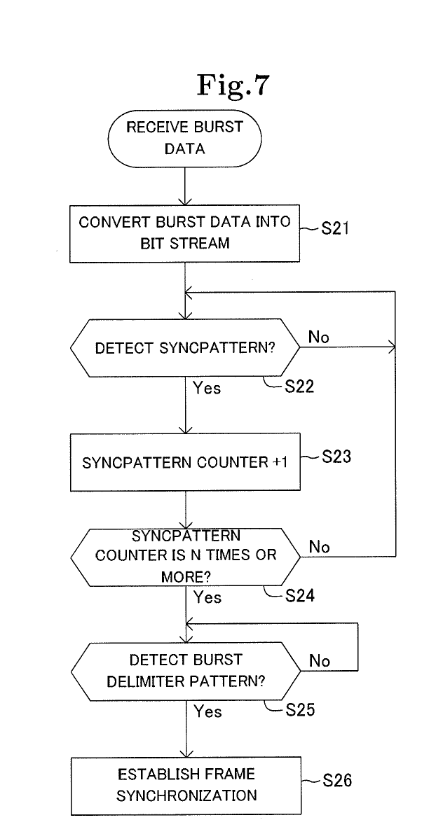

A first exemplary embodiment of the present invention will be described with reference to FIGS. 2 to 7. FIGS. 2 to 4 are diagrams showing the configuration of a communication system according to the present embodiment, and FIG. 5 is an illustration showing the configuration of data to be transmitted in the communication system. FIGS. 6 and 7 are flowcharts showing the operation of the communication system.

### [Configuration]

The communication system according to the present embodiment is a 10 G EPON system. As shown in FIG. 2, the 10 G EPON system includes, for example, a plurality of user-side devices (ONU: Optical Network Unit) 31, 32, . . . , 3n provided at stations and the like, and a center-side device (OLT: Optical Line Terminal) 1 which terminates optical signals from the user-side devices 31 to 3n. The user-side devices are connected with the center-side device 1 via a splitter 2, and the center-side device 1 is connected with a network N of the Ethernet (registered trademark) or the like.

The splitter 2 is a device which splits optical signals between the center-side device 1 and the user-side devices 31 to 3n.

The user-side devices 31 to 3n are respectively connected with respective user terminals 41, 42, . . . , 4n which transmit and receive actual application data.

When downstream transmission (transmission in a direction from the center-side device 1 to the user terminals 41 to 4n) is performed in the 10 G EPON system of the above-described configuration, the center-side device 1 performs broadcasting, and the respective user-side devices 41 to 4n select and receive data which should be received.

On the other hand, when upstream transmission (transmission in a direction from the user terminals 41 to 4n to the center-side device 1) is performed in the 10 G EPON system of the above-described configuration, there is a possibility that the user-side devices 31 to 3n transmit data simultaneously to the center-side device 1. As such, time slots are assigned to the user-side devices 31 to 3n, whereby time-division multiplexing of the data is performed.

To be specific, the user-side devices 31 to 3n transmit upstream burst data, as shown in FIG. 5, at timings assigned by time-division multiplexing. The center-side device 1 receives the data in a burst mode, and acquires FEC-coded data.

Here, the configuration of upstream burst data received in a burst mode by the center-side device 1 will be described with reference to FIG. 5. FIG. 5 shows the configuration of upstream burst data 100 to be transmitted from the user-side devices 31 to 3n of the 10 G EPON system defined in IEEE802.3av. In FIG. 5, a Ton 107 shows a period from the time when transmission of upstream burst data is instructed to the PMD function of each of the user-side devices 31 to 3n until the time when a SyncPattern 103 is actually transmitted from an optical module.

The SyncPattern 103 includes a certain number of 66-bit sync patterns defined in IEEE802.3av to be used for recovery of a reception clock and control of optical gains on the side of the center-side device 1. An EOB (End Of Burst delimiter) 105 includes a certain number of 66-bit patterns indicating an end of a frame. A Toff 108 shows a period from the time when the EOB 105 is transmitted until the time when the optical module of the user-side device 31 to 3n is extinct. As IEEE802.3av defines that frames to be used must be FEC (Forward Error Correction) coded, a frame is described as an FEC code in the following description.

Further, an FEC code string 101 includes a plurality of FEC-coded FEC CWs 104. In the center-side device 1, the FEC CWs 104 must be detected and transmitted to the higher layer.

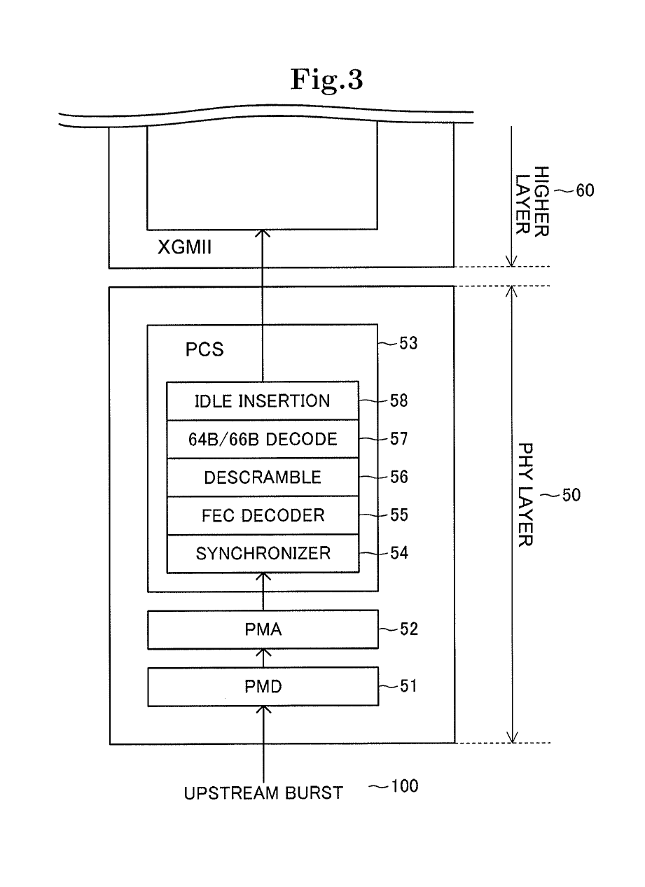

Next, FIG. 3 shows the configuration of a functional block diagram of an upstream path of a PHY layer 50 having a burst reception function in the center-side device 1. The configuration of this functional block conforms to IEEE802.3av Clause 76. Specifically, the PHY layer 50 in the upstream path receives upstream burst 100 by the PMD function 51, and transmits it from a PCS function 53 to a higher layer 60 via a 66-bit XGMII interface.

To be specific, a synchronizer function 54 in the PCS function 53 shown in FIG. 3 receives data of the upstream burst 100 from the PMA function 52 via the 16-bit XSBI interface, and generates a bit stream from the received data (conversion means). Then, the synchronizer function 54 performs matching on data in the generated bit stream to determine whether there are a specified sync pattern and a burst delimiter pattern (matching means), to thereby detect an FEC code start position in the bit stream and perform FEC code synchronization (synchronization means). Then, the synchronizer function 54, which performed FEC code synchronization and acquired an FEC code, transmits the acquired FEC code to an FEC decoder function 55 in units of FEC-coded data. The acquisition of FEC codes is continued until an EOB pattern is detected from the bit stream.

It should be noted that the functions of the synchronizer function 54 and the like are built by programs installed in the arithmetic unit of the server-side device 1. Alternatively, they may be configured by analog circuits.

As the above-described functions such as the PMD 51, the PMA 52, the FEC decoder 55, the descramble 56, the 64 B/66 B decode 57, and the idle insertion 58 are well known to those skilled in the art, the detailed configurations thereof are not described herein.

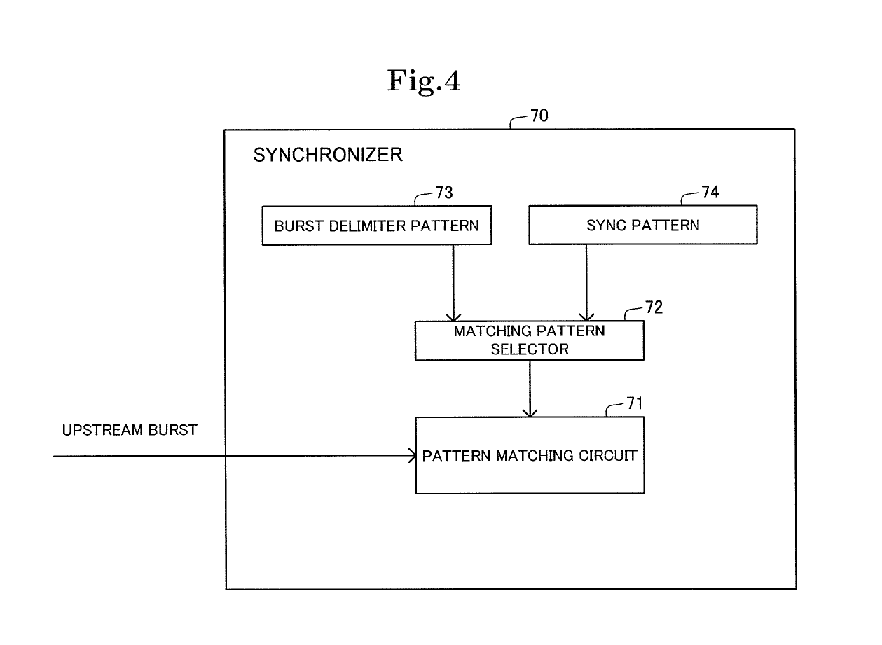

Next, the synchronizer function 54 will be further described in detail with reference to FIG. 4. FIG. 4 shows an exemplary circuit configuration of the synchronizer function 70 (54). In FIG. 4, the synchronizer function 70 (54) includes a pattern matching circuit 71 and a matching pattern selector 72, and stores a burst delimiter pattern 73 and a sync pattern 74.

The pattern matching circuit 71 is a circuit which performs matching on data in the upstream burst data 100 received from the PMA function 52 shown in FIG. 3, and detects whether the data matches matching patterns such as the burst delimiter pattern 73 and the sync pattern 74. The matching pattern selector 72 selects matching patterns to be used for matching performed by the pattern matching circuit 71, from the burst delimiter pattern 73 and the sync pattern 74. Specifically, the matching pattern selector 72 first selects the sync pattern 74 as a matching pattern, and the pattern matching circuit 71 detects matching between the data in the upstream burst data 100 and the sync pattern 74. Then, after the sync pattern 74 was detected for a certain number of times, the matching pattern selector 72 switches the matching pattern to the burst delimiter pattern 73, and the pattern matching circuit 71 detects matching between the data in upstream burst data 100 and the burst delimiter pattern 73.

In this step, a circuit for detecting a burst delimiter provided to the burst delimiter detection circuit, defined in IEEE802.3av, can also be used for detecting a sync pattern. This means that detection of a sync pattern and a burst delimiter, as described above, can be implemented by the same pattern matching circuit 71. As such, by applying some changes to the existing burst delimiter detection circuit, it is possible to add a sync pattern detection function while preventing an increase of additional circuits, leading to a significant improvement in the detection capability.

Then, by performing matching of the specified sync pattern and the burst delimiter pattern on the generated bit stream, the synchronizer function 70 (54) is able to detect an FEC code start position in the bit stream and to perform FEC code synchronization.

### [Operation]

Next, operation of the communication system configured as described above, and in particular, an outline of the operation of the center-side device 1, will be described with reference to FIG. 6. First, the center-side device 1 receives upstream burst data transmitted from the respective user-side devices 31 to 3n by time-division multiplexing (TDM), and converts the upstream burst data into bit stream data (step S11). Then, the center-side device 1 performs matching of the SyncPattern (sync pattern) from the generated bit stream data, that is, detection of SyncPattern having a predetermined pattern.

After successful detection of the SyncPattern (step S12: Yes), the center-side device 1 then performs matching of the burst delimiter from the bit stream data, that is, detection of a predetermined burst delimiter (step S13). If detection of the burst delimiter succeeded (step S13: Yes), the center-side device 1 establishes frame synchronization (step S14).

As described above, in the present embodiment, detection of a frame start position, which is performed for frame synchronization by the center-side device 1, includes a condition that a sync pattern transmitted from the user-side devices 31 to 3n before the burst delimiter has been detected, in addition to matching of the burst delimiter. Thereby, erroneous detection of a frame start position can be reduced, and erroneous synchronization of a frame can be reduced.

While the center-side device 1 of the present embodiment may perform processing as described above, the center-side device 1 further operates as shown below in the present embodiment.

To be specific, the flow of frame synchronization processing of a burst frame by the synchronizer function 54 of the center-side device 1 according to the present embodiment will be described with reference to FIG. 7.

First, the synchronizer function receives upstream burst data from the PMA function via the 10 G interface, and generates a bit stream from the received data (step S21).

Then, the synchronizer function performs matching to determine whether a bit string from the beginning of the generated bit stream up to the number of bit of the SyncPattern length matches the predetermined SyncPattern within a certain Hamming distance (step S22). In this step, if the predetermined SyncPattern was not detected so that matching failed (step S22: No), the synchronizer function shifts the beginning position of the bit stream on which matching is performed, and performs matching with the predetermined SyncPattern again (step S22).

Then, if the predetermined SyncPattern is detected in the bit stream and matching is performed successfully (step S22: Yes), a value representing the number of times that the SyncPattern matched, stored in the center-side device 1, is incremented by “+1” (step S23), and then the synchronizer function determines whether the number of times that the SyncPattern matched is not less than a predetermined number of times (S24). In this step, if the number of times that the SyncPattern matched is less than the predetermined number of times (step S24: No), the synchronizer function shifts the beginning position of the bit stream on which matching is performed, performs matching with the predetermined SyncPattern again (step S22), and repeats this processing (step S22 to S24).

If the number of times that the SyncPattern matched becomes the predetermined number of times or larger (step S24: Yes), the synchronizer function shifts the beginning position of the bit stream on which matching is performed, and performs matching to determine whether the bit string from the beginning position up to the number of bit of the burst delimiter length matches a predetermined burst delimiter pattern within a certain Hamming distance (step S25). In this step, if matching with the predetermined burst delimiter pattern failed (step S25: No), the synchronizer function shifts the beginning position of the bit stream on which matching is performed, and performs matching with the burst delimiter pattern again (step S25).

If matching with the predetermined burst delimiter pattern succeeded (step S25: Yes), the synchronizer function fixes the beginning position of the frame based on the position where the matching succeeded in the bit stream, and establishes frame synchronization (step S26).

It should be noted that the setting of the Hamming distance in the matching and determination in steps S22 and S25 and the setting of the number of matching times of the SyncPattern in step S24 shown in FIG. 7, as described above, can be changed. For example, the number of matching times may be multiple times or one time.

Further, as this processing is positioned as a synchronizer function because burst frame synchronization is performed by the synchronizer function in the provisions of IEEE802.3av, burst frame synchronization may be performed by a function other than the synchronizer function defined in IEEE802.3av.

As described above, according to the network system of the present embodiment, it is possible to reduce erroneous synchronization of an FEC code in the upstream burst and erroneous detection of a frame check error associated with it, by the center-side device 1. This is because the probability of erroneous detection of the FEC code start position is reduced by applying a condition that matching with the sync pattern sequence (particularly, matching for a number of times), besides the burst delimiter, is performed for detecting the FEC code start position.

Further, the probability that the upstream burst is not treated can be reduced in the center-side device 1. This is because as the probability of FEC code erroneous synchronization is reduced as described above, the probability of an occurrence of a state where upstream burst is received during the erroneous synchronization and burst cannot be detected will be reduced.

It should be noted that as the present invention relates to a method of frame synchronization, the present invention is applicable even if a burst frame does not use an FEC code.

### <Supplementary Notes>

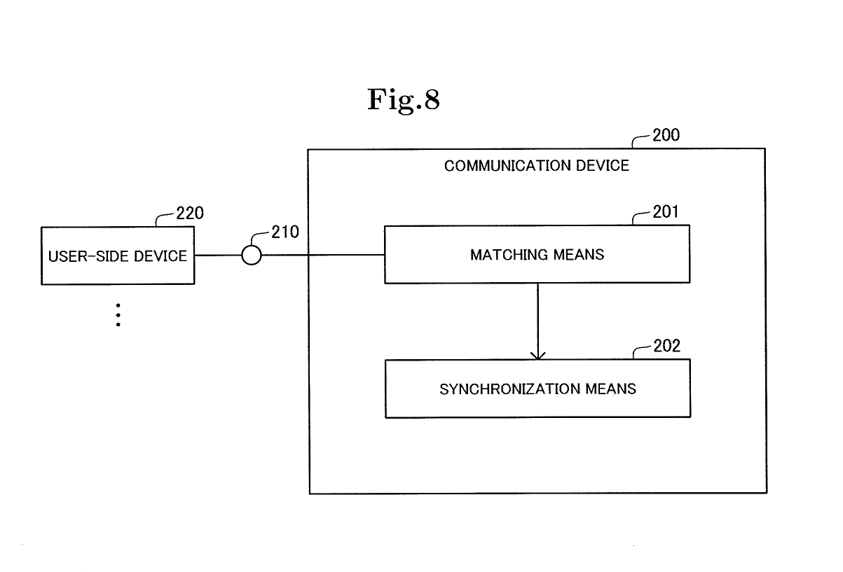

The whole or part of the exemplary embodiments disclosed above can be described as, but not limited to, the following supplementary nodes. Hereinafter, an outline of the configuration of a communication device according to the present invention will be described with reference to the block diagram of FIG. 8. Further, outlines of the configurations of a communication system, a program, and a communication method, according to the present invention, will be described. However, the present invention is not limited to the configurations described below.

### (Supplementary Note 1)

A communication device 200 connected with a plurality of user-side devices 220 via a splitter 210, the device 200 comprising:

a matching means 201 for performing matching to determine whether each of a burst delimiter and sync pattern data matches a predetermined pattern, the burst delimiter being positioned at a start position of frame data which is a synchronization target in a burst optical signal transmitted from each of the user-side devices 220, the sync pattern data being positioned from the beginning of the burst optical signal to the burst delimiter in the burst optical signal; and

a synchronization means 202 for, if matching of the sync pattern data and matching of the burst delimiter by the matching means 201 succeeded, performing synchronization of the frame data on the basis of the position of the burst delimiter in the burst optical signal, wherein the matching means 201 performs matching of the burst delimiter after successful matching of the sync pattern data.

### (Supplementary Note 2)

The communication device according to supplementary note 1, wherein

the matching means performs matching of the burst delimiter if matching of the sync pattern data succeeded a predetermined number of times.

### (Supplementary Note 3)

The communication device according to supplementary note 1 or 2, wherein

the matching means performs matching of the sync pattern data and matching of the burst delimiter on the same circuit.

### (Supplementary Note 4)

The communication device according to any of supplementary notes 1 to 3, wherein

the matching means performs matching on data of a given amount from the beginning of the burst optical signal as the sync pattern data, and if the matching failed, shifts the beginning position of the burst optical signal backward by a given amount and performs matching on data of a given amount from the shifted beginning position as the sync pattern data.

### (Supplementary Note 5)

The communication device according to any of supplementary notes 1 to 4, wherein

the matching means performs matching to determine whether the sync pattern data matches the predetermined pattern within a certain Hamming distance.

### (Supplementary Note 6)

The communication device according to any of supplementary notes 1 to 5, further comprising

a conversion means for converting the burst optical signal into a bit stream signal, wherein

the matching means performs matching of the sync pattern data and matching of the burst delimiter based on the bit stream signal converted by the conversion means.

### (Supplementary Note 7)

The communication device according to any of supplementary notes 1 to 6, wherein the burst optical signal includes the sync pattern data and the burst delimiter which are defined in IEEE802.3av.

### (Supplementary Note 8)

A communication system comprising a plurality of user-side devices connected via a splitter, and a communication device which receives, in a burst mode, a burst optical signal transmitted from each of the user-side devices, wherein

the communication device includes:
a matching means for performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and
a synchronization means for, if matching of the sync pattern data and matching of the burst delimiter by the matching means succeeded, performing synchronization of the frame data on the basis of the position of the burst delimiter in the burst optical signal, wherein

the matching means performs matching of the burst delimiter after successful matching of the sync pattern data.

### (Supplementary Note 9)

The communication system according to supplementary note 8, wherein

the matching means included in the communication device performs matching of the burst delimiter if matching of the sync pattern data succeeded a predetermined number of times.

### (Supplementary Note 10)

A computer-readable recording medium storing a program for causing a communication device, connected with a plurality of user-side devices via a splitter, to realize:

a matching means for performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

a synchronization means for, after successful matching of the sync pattern data by the matching means, if matching of the burst delimiter succeeded, performing synchronization of the frame data on the basis of the position of the burst delimiter in the burst optical signal.

### (Supplementary Note 11)

A computer-readable recording medium storing the program according to supplementary note 10, wherein

the matching means performs matching of the burst delimiter if matching of the sync pattern data succeeded a predetermined number of times.

### (Supplementary Note 12)

A communication method comprising, in a network system including a plurality of user-side devices connected via a splitter and a communication device which receives, in a burst mode, a burst optical signal transmitted from each of the user-side devices:

by the communication device, performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and

after successful matching of the sync pattern data, if matching of the burst delimiter succeeded, performing synchronization of the frame data on the basis of the position of the burst delimiter in the burst optical signal.

### (Supplementary Note 13)

The communication method according to supplementary note 12, wherein

the synchronization of the frame data is performed if matching of the burst delimiter succeeded after matching of the sync pattern data had succeeded a predetermined number of times.

It should be noted that the above-described program may be stored in a storage device or recorded on a computer-readable recording medium. A recording medium is a portable medium such as a flexible disk, an optical disk, a magneto-optical disk, or a semiconductor memory, for example.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2010-166845, filed on Jul. 26, 2010, the disclosure of which is incorporated herein in its entirety by reference.

### DESCRIPTION OF REFERENCE NUMERALS

1 center-side device (OLT)
2 splitter
31, 32, 3n user-side device (ONU)
41, 42, 4n user terminal
50 PHY layer
51 PMD
52 PMA
53 PCS
54 synchronizer
55 FEC decoder
56 descramble
57 64 B/66 B decode
58 idle insertion
60 higher layer
70 synchronizer
71 pattern matching circuit
72 matching pattern selector
73 burst delimiter pattern
74 sync pattern
100 upstream burst
200 communication device
201 matching means
202 synchronization means
210 splitter
220 user-side device

1. A communication device connected with a plurality of user-side devices via a splitter, the device comprising:
a matching unit that performs matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and
a synchronization unit that, if matching of the sync pattern data and matching of the burst delimiter by the matching unit succeeded, performs synchronization of the frame data on the basis of the position of the burst delimiter in the burst optical signal, wherein
the matching unit performs matching of the burst delimiter after successful matching of the sync pattern data.

2. The communication device according to claim 1, wherein
the matching unit performs matching of the burst delimiter if matching of the sync pattern data succeeded a predetermined number of times.

3. The communication device according to claim 1, wherein
the matching unit performs matching of the sync pattern data and matching of the burst delimiter on the same circuit.

4. The communication device according to claim 1, wherein
the matching unit performs matching on data of a given amount from the beginning of the burst optical signal as the sync pattern data, and if the matching failed, shifts the beginning position of the burst optical signal backward by a given amount and performs matching on data of a given amount from the shifted beginning position as the sync pattern data.

5. The communication device according to claim 1, wherein
the matching unit performs matching to determine whether the sync pattern data matches the predetermined pattern within a certain Hamming distance.

6. The communication device according to claim 1, further comprising
a conversion unit that converts the burst optical signal into a bit stream signal, wherein
the matching unit performs matching of the sync pattern data and matching of the burst delimiter based on the bit stream signal converted by the conversion unit.

7. The communication device according to claim 1, wherein
the burst optical signal includes the sync pattern data and the burst delimiter which are defined in IEEE802.3av.

8. (canceled)

9. A non-transitory computer-readable recording medium storing a program comprising instructions for causing a communication device, connected with a plurality of user-side devices via a splitter, to realize:
a matching unit that performs matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and
a synchronization unit that, after successful matching of the sync pattern data by the matching unit, if matching of the burst delimiter succeeded, performs synchronization of the frame data on the basis of the position of the burst delimiter in the burst optical signal.

10. A communication method comprising, in a network system including a plurality of user-side devices connected via a splitter and a communication device which receives, in a burst mode, a burst optical signal transmitted from each of the user-side devices:
by the communication device, performing matching to determine whether each of a burst delimiter and sync pattern data matches a predetermined pattern, the burst delimiter being positioned at a start position of frame data which is a synchronization target in a burst optical signal transmitted from each of the user-side devices, the sync pattern data being positioned from the beginning of the burst optical signal to the burst delimiter in the burst optical signal; and
after successful matching of the sync pattern data, if matching of the burst delimiter succeeded, performing synchronization of the frame data on the basis of the position of the burst delimiter in the burst optical signal.

11. A non-transitory computer-readable recording medium storing the program according to claim 9, wherein
the matching unit performs matching of the burst delimiter if matching of the sync pattern data succeeded a predetermined number of times.

12. The communication method according to claim 10, wherein
the synchronization of the frame data is performed if matching of the burst delimiter succeeded after matching of the sync pattern data had succeeded a predetermined number of times.
